(19) United States
(12) Patent Application Publication
(10) Pub. No.: US 2012/0183393 A1
(43) Pub. Date: Jul. 19, 2012

(54) ASSEMBLY AND METHOD FOR PREVENTING FLUID FLOW

(75) Inventors: Mehmet Demiroglu, Troy, NY (US); Benjamin Paul Lacy, Greer, SC (US); Neelesh Nandkumar Sarawate, Niskayuna, NY (US)

(73) Assignee: GENERAL ELECTRIC COMPANY, Schenectady, NY (US)

(21) Appl. No.: 13/006,695

(22) Filed: Jan. 14, 2011

(51) Int. Cl. F01D 11/00; F16J 15/02

(52) U.S. Cl. 415/196; 277/647; 277/312

(57) ABSTRACT

According to one aspect of the invention, an assembly to be placed between adjacent turbomachinery components is provided, where the assembly includes a first shim comprising a U-shaped cross-section geometry, wherein the first shim is configured to form a seal between adjacent components. The assembly also includes an insert placed within a recess of the U-shaped cross-section geometry of the first shim and a plurality of staggered couplings between the insert and the first shim.

### FEDERAL RESEARCH STATEMENT

This invention was made with Government support under Contract No. DE-FC26-05NT42643, awarded by the US Department of Energy (DOE). The Government has certain rights in this invention.

### BACKGROUND OF THE INVENTION

The subject matter disclosed herein relates to turbomachinery. More particularly, the subject matter relates to shims and seals between components of turbines.

In a turbine, a combustor converts the chemical energy of a fuel or an air-fuel mixture into thermal energy. The thermal energy is conveyed by a fluid, often compressed air from a compressor, to a turbine where the thermal energy is converted to mechanical energy. Increased conversion efficiency leads to reduced emissions. Several factors influence the efficiency of the conversion of thermal energy to mechanical energy. The factors may include blade passing frequencies, fuel supply fluctuations, fuel type and reactivity, combustor head-on volume, fuel nozzle design, air-fuel profiles, flame shape, air-fuel mixing, flame holding and gas flow leakages between components. For example, leaks in flow of air from the compressor discharge casing side of the combustor through the interface between the transition piece(s) and the stage one turbine nozzle(s) can cause increased emissions by causing air to bypass the combustor resulting in higher peak gas temperatures. Leaks may be caused by thermal expansion of certain components and relative movement between components. Accordingly, reducing gas leaks between shifting or non-aligned turbine components can improve efficiency and performance of the turbine.

### BRIEF DESCRIPTION OF THE INVENTION

According to one aspect of the invention, an assembly to be placed between adjacent turbomachinery components is provided, where the assembly includes a first shim comprising a U-shaped cross-section geometry, wherein the first shim is configured to form a seal between adjacent components. The assembly also includes an insert placed within a recess of the U-shaped cross-section geometry of the first shim and a plurality of staggered couplings between the insert and the first shim.

According to another aspect of the invention, a method for reducing fluid flow between adjacent turbomachinery components, the method including bending a first shim to form a U-shaped cross-section geometry and placing a insert within a recess of the first shim. The method further includes coupling the insert to the first shim via a plurality of staggered couplings and placing the first shim and insert between adjacent components to reduce a fluid flow.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic drawing of an embodiment of a gas turbine engine, including a combustor, fuel nozzle, compressor and turbine;

FIG. 2 is a perspective view of embodiments of seal assemblies to be placed between turbine components;

FIG. 3 is a sectional side view of an embodiment of a seal assembly;

FIG. 4 is a top view of an embodiment of a seal assembly;

FIG. 5 is a perspective view of a portion of an exemplary transition piece assembly including a pair of seal assemblies;

FIG. 6 is an end view of an embodiment of a shroud from a gas turbine;

FIG. 7 is a detailed side view of a shroud assembly shown in FIG. 6; and

FIG. 8 shows a perspective view of another embodiment of a shim assembly;

FIG. 9 shows a perspective view of yet another embodiment of a shim assembly.

The detailed description explains embodiments of the invention, together with advantages and features, by way of example with reference to the drawings.

### DETAILED DESCRIPTION OF THE INVENTION

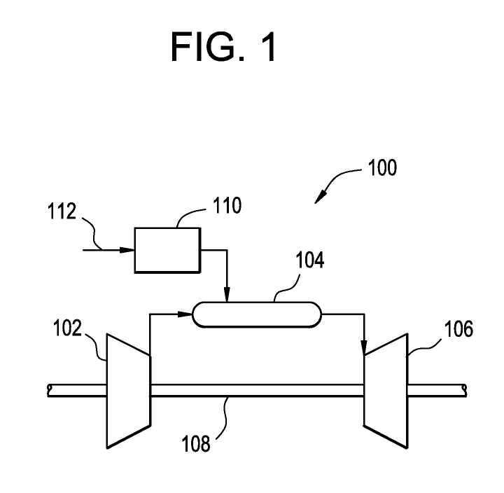

FIG. 1 is a schematic diagram of an embodiment of a turbomachine system, such as a gas turbine system 100. The system 100 includes a compressor 102, a combustor 104, a turbine 106, a shaft 108 and a fuel nozzle 110. In an embodiment, the system 100 may include a plurality of compressors 102, combustors 104, turbines 106, shafts 108 and fuel nozzles 110. The compressor 102 and turbine 106 are coupled by the shaft 108. The shaft 108 may be a single shaft or a plurality of shaft segments coupled together to form shaft 108.

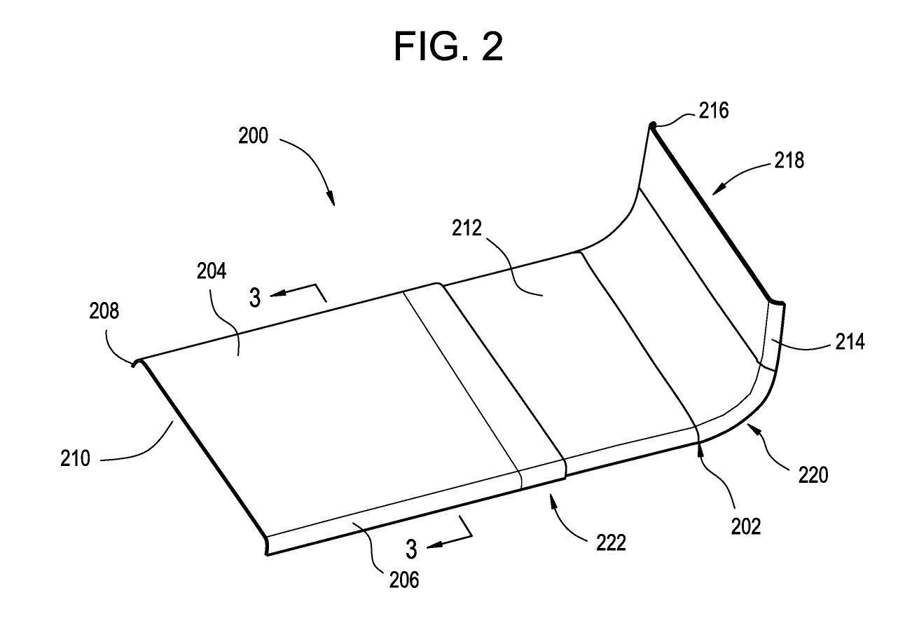

In an aspect, the combustor 104 uses liquid and/or gas fuel, such as natural gas or a hydrogen rich synthetic gas, to run the engine. For example, fuel nozzles 110 are in fluid communication with an air supply and a fuel supply 112. The fuel nozzles 110 create an air-fuel mixture, and discharge the air-fuel mixture into the combustor 104, thereby causing a combustion that creates a hot pressurized exhaust gas. The combustor 100 directs the hot pressurized exhaust gas through a transition piece into a turbine nozzle (or “stage one nozzle”), causing turbine 106 rotation. The rotation of turbine 106 causes the shaft 108 to rotate, thereby compressing the air as it flows into the compressor 102. In an embodiment, each of an array of combustors is coupled to a transition piece positioned between the combustor and a nozzle of the turbine. Assemblies and sealing mechanisms between these and other turbine parts are discussed in detail below with reference to FIGS. 2-9.

FIG. 2 is a perspective view of an embodiment of a first seal assembly 200 and second seal assembly 202. The first seal assembly 200 includes a shim 204 with raised edges 206 and 208. The raised edges 206 and 208 form a recess 210 to receive an insert (not shown). The cross section geometry of the shim 204 is a U-shape, wherein the raised edges 206 and 208 are longitudinal sides of the shim 204 structure. The raised edges 206 and 208 are at an angle with respect to the center of shim 204, wherein the angle ranges from about 30 to about 150 degrees. In an embodiment, the angle of raised edges 206 and 208 is about 80 to about 100 degrees. The second seal assembly 202 includes a shim 212 with raised edges 214 and 216 that also form a U-shape with recess 218. The recess 218 is also configured to receive an insert. In an embodiment, the inserts are flexible or conformable to improve contact with adjacent turbine components or parts, thereby improving the seal between adjacent turbine components. The shim 212 includes a corner 220, wherein the corner 220 is bent at an angle to provide a continuous seal at an intersection of two substantially straight seal sections. In current art two straight seal pieces meet at an intersection, wherein a fluid flow may leak at the intersection of the unconnected straight seal pieces. As depicted in FIG. 2, the first seal assembly 200 and second seal assembly 202 overlap one another, as indicated by element 222. Thus, a continuous assembly is formed from the two assemblies 200 and 202 to provide a seal between turbine components, thus reducing fluid flow across seal assemblies 200 and 202. In embodiments, the overlapping portions 222 provide reduced leakage at an angled seal area or intersection of seal assemblies. The shim 204 is made from a suitable durable material to withstand the temperature, pressure and wear within a gas turbine. Exemplary materials for shim 204 include, metal alloys, stainless steel, high strength polymers and composite materials.

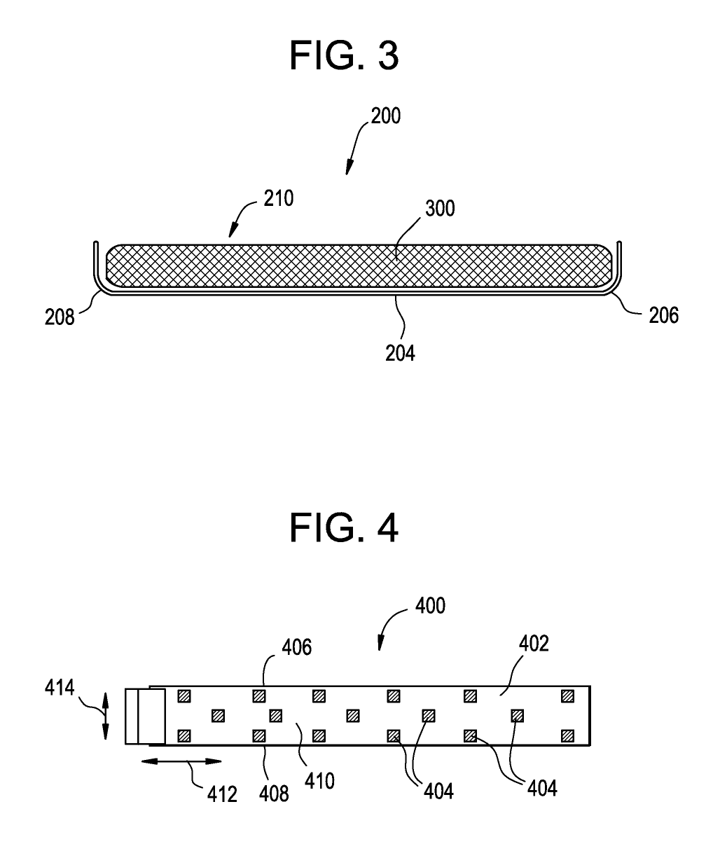

FIG. 3 is a sectional view of exemplary seal assembly 200, wherein the U-shaped geometry of shim 204 is illustrated. An insert 300 is positioned in recess 210, wherein the insert 300 is configured to flex or conform the assembly 200 to adjacent gas turbine components, thereby providing an improved seal. For example, the seal assembly 200 is placed between parts of a shroud in a gas turbine, where the parts may shift or move over time. The flexible seal assembly 200 reduces leakage when the parts are not aligned (“non-aligned parts or components”). Further, the seal assembly 200 reduces leakage of fluid from a hot gas path from outside the shroud to inside the shroud. The insert 300 may be an insert of any durable material capable of withstanding conditions inside the gas turbine, such as woven cloth twill metallic material or woven polymer fibers. In the depicted embodiment, the U-shaped geometry of shim 204 allows bending/stamping/molding to form corner 220, further improving the seal between turbine parts. In embodiments, the cross section of shim 204 is any suitable cross section that enables sealing while being flexible to adapt to angled and curved sealing slots between components without affecting the structural integrity of the seal. Exemplary cross sections of shim 204 include U-shaped, W-shaped and V shaped.

FIG. 4 is a schematic view of an embodiment of a seal assembly 400 to be placed between adjacent turbine components. The seal assembly 400 includes a shim 402 and welds 404, where the welds 404 couple the shim 402 to the insert 300 (FIG. 3). The shim 402 has a U-shaped structure with raised edges 406 and 408 running along longitudinal sides of the shim 402. A recess 410 is formed in the shim 402 to receive the insert 300, as shown in FIG. 3. In the embodiment of FIG. 4, the welds 410 are described as staggered welds, wherein the pattern and spacing of the welds improve flexibility of the seal assembly 400, thereby enabling a bending of the seal assembly 400 for improved seals, such as formed by corner 220 (FIG. 1). The formation and deposit of weld materials on shim 402 may reinforce and stiffen the shim 402 structure, thereby reducing flexibility of the seal assembly 400. Thus, by staggering or other layouts of the welds 404 on the shim 402, the seal assembly 400 may achieve improved flexibility and conform to curved or angled sealing areas as well as to non-aligned adjacent turbine components. The welds 404 may be any suitable couplings or mechanism to couple insert 300 (FIG. 3) to shim 402, such as tack welds, spot welds, brazing, adhesives or other high strength bonding techniques. In the depicted embodiment, the welds 404 are staggered due to the fact that longitudinal 412 columns of welds 404 include an alternating number of welds. For example, a first column of welds 404 include two welds 404 spaced laterally 414, while the next column of welds 404 includes one weld 404 centered laterally 414.

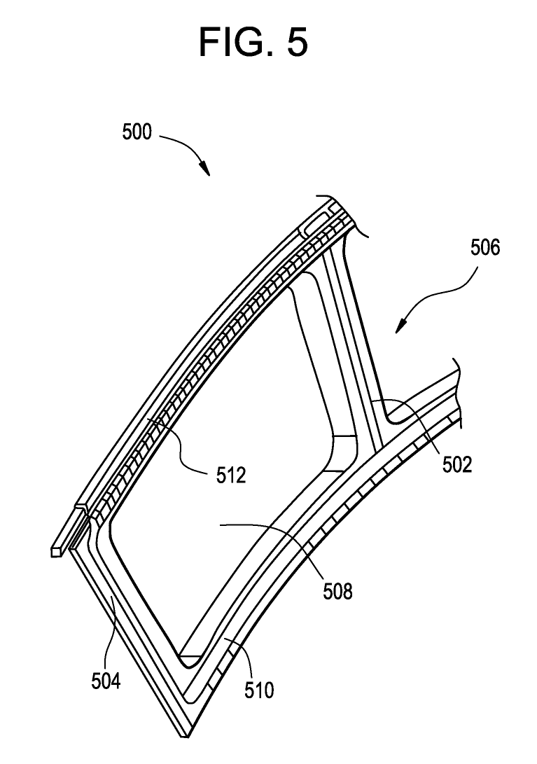

FIG. 5 is a perspective view of an embodiment of a transition piece assembly 500 with side seals 502 and 504 (also referred to as “seal assemblies”). The transition piece assembly 500 includes transition pieces 506 and 508 configured to provide a hot gas path into a turbine nozzle assembly. The side seals 502 and 504, along with inner transition seal 510 and outer transition seal 512, reduce leakage of fluid flow through the transition piece assembly. Specifically, the side seals 502 and 504 each include shim 204 (FIG. 2) with a U-shaped cross section and insert 300 (FIG. 3). The U-shaped geometry of the shim 204 and insert 300 are configured conform to movement of the adjacent transition pieces 506 and 508, thereby reducing leakage of hot gas when the pieces 506 are 508 are not aligned or move during operation of the turbine. In addition, the side seals 502 and 504 include staggered welds 404 (FIG. 4) to further improve flexibility.

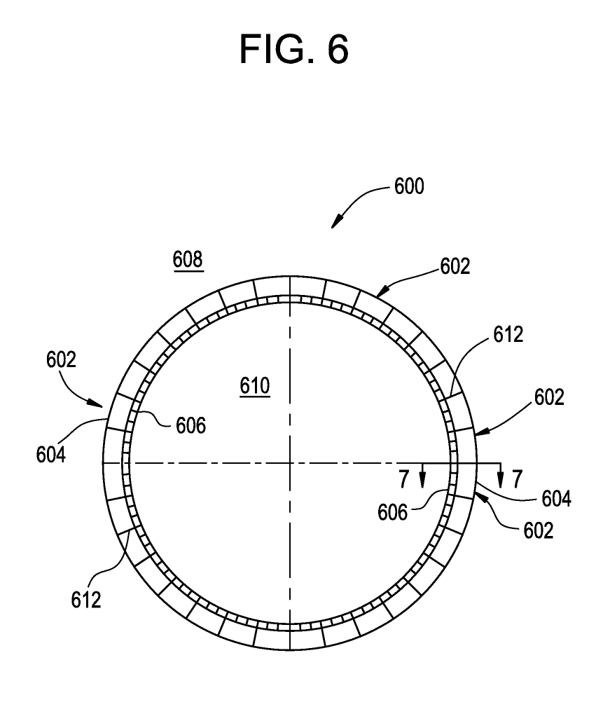

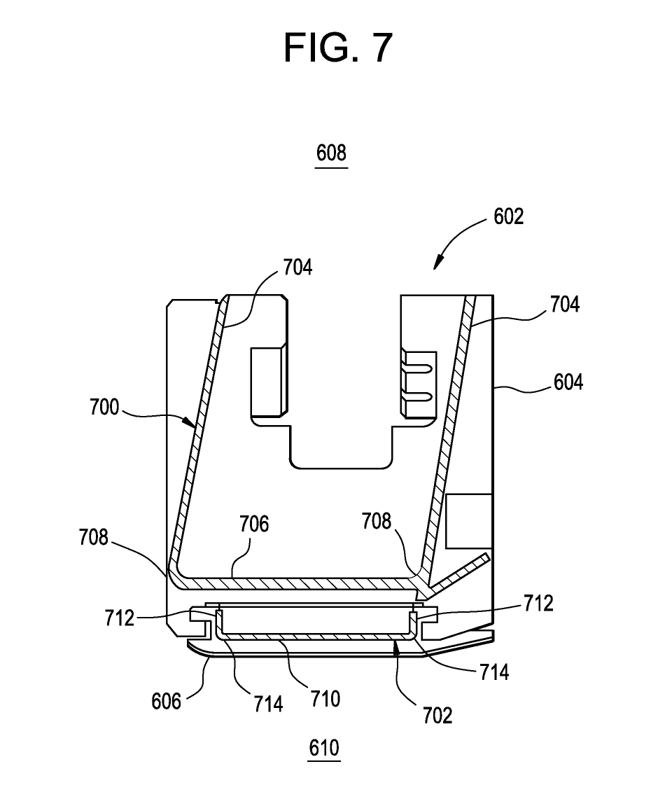

FIG. 6 is an end view of an embodiment of a shroud 600 of a gas turbine that includes a plurality of shroud assemblies 602. FIG. 7 is a detailed view of a single shroud assembly 602. The shroud assembly 602 includes an outer shroud 604 and inner shroud 606. As shown in FIG. 6, the shroud assemblies 602 are joined circumferentially to one another to separate fluid flow regions, including hot gas path 608 and cooler gas path 610. A joint or interface 612 between each of the shroud assemblies 602 includes seals and assemblies to reduce fluid communication between hot gas path 608 and cooler gas path 610, as illustrated in FIG. 7. An outer shroud seal assembly 700 and inner shroud seal assembly 702 are configured to reduce leakage between flow paths (608, 610) and maintain a seal when the adjacent shroud assemblies 602 are not aligned or move during operation of the turbine. The outer shroud seal assembly 700 includes vertical portions 704 and a horizontal portion 706. Corners 708 of the outer shroud seal assembly 700 are formed to provide an improved seal at the intersection of vertical portions 704 and horizontal portion 706. Similarly, the inner shroud seal assembly 702 includes vertical portions 712 and a horizontal portion 710. Corners 714 of the inner shroud seal assembly 702 are formed to provide an improved seal at the intersection of vertical portions 712 and horizontal portion 710. An embodiment of the shroud seal assemblies 700 and 702 include shims 204 (FIG. 2) and inserts 300 (FIG. 3), wherein the U-shaped geometry of the shims 204 enables bending of the assemblies 700 and 702 to seal curved portions, such as corners 708 and 714. Further, the shroud seal assemblies 700 and 702 include staggered welds 404 (FIG. 4) coupling the inserts 300 to the shims 204, wherein the configuration of the welds 404 improves flexibility to reduce leakage of fluid across the seal assemblies 700 and 702. Moreover, the depicted assembly and sealing method may be used on any hot gas path part, including nozzles, buckets, transition pieces, using a similar interface between adjacent parts.

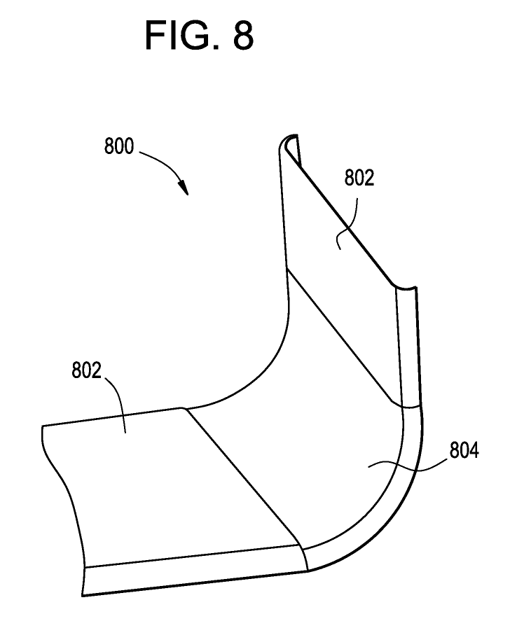

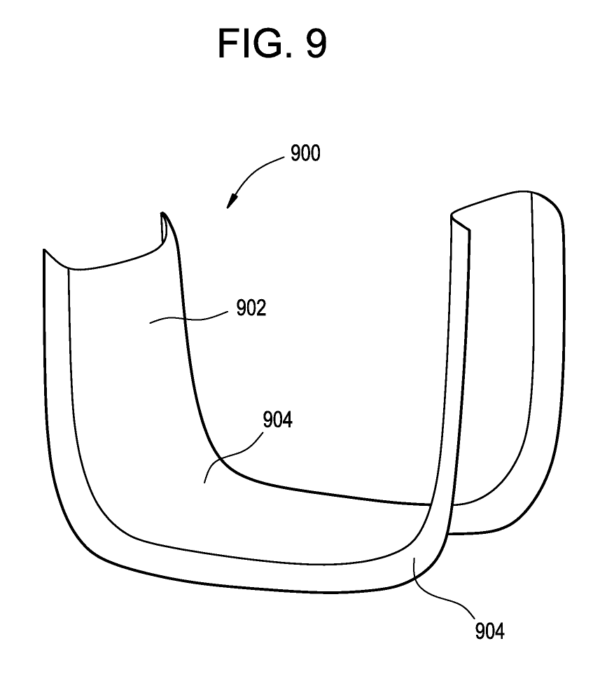

FIG. 8 shows an alternative embodiment of a shim assembly 800 including two substantially straight shim pieces 802 joined by a bent or curved piece 804. In this configuration, the straight shim pieces 802 are U-shaped while the bent piece 804 may optionally have a U-shaped cross section. FIG. 9 is an embodiment of a shim assembly 900 where a single shim member 902 is formed, bent or stamped to form a single continuous piece with multiple bends 904.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An assembly to be placed between adjacent turbomachinery components, the assembly comprising:
a first shim comprising a U-shaped cross-section geometry, wherein the first shim is configured to form a seal between adjacent components;
an insert placed within a recess of the U-shaped cross-section geometry of the first shim; and
a plurality of staggered couplings between the insert and the first shim.

2. The assembly of claim 1, wherein the first shim comprises a stainless steel.

3. The assembly of claim 1, wherein the assembly is bent to provide a seal preventing fluid flow at a corner of the seal between adjacent turbomachinery components.

4. The assembly of claim 1, wherein the first shim comprises a member with bends configured to prevent fluid flow at corners between the adjacent turbomachinery components.

5. The assembly of claim 1, comprising a second shim comprising a U-shaped cross-section geometry, wherein a portion of the second shim overlaps a portion of the first shim to provide a seal between the first and second shims.

6. The assembly of claim 1, comprising two substantially straight shim members, each comprising a U-shaped cross-section geometry, wherein each shim member overlaps a third bent member.

7. The assembly of claim 1, wherein the assembly comprises the seal configured to prevent fluid flow between adjacent components that form a hot gas path within a turbine.

8. The assembly of claim 7, wherein the adjacent components comprise one selected from the group consisting of: adjacent shroud assemblies, adjacent transition pieces, nozzles and buckets.

9. The assembly of claim 1, wherein the adjacent components comprise non-aligned components.

10. The assembly of claim 1, wherein the plurality of couplings comprise welds coupling the insert and first shim.

11. A method for reducing fluid flow between adjacent turbomachinery components, the method comprising:
bending a first shim to form a U-shaped cross-section geometry;
placing an insert within a recess of the first shim;
coupling the insert to the first shim via a plurality of staggered couplings; and
placing the first shim and insert between adjacent components to reduce a fluid flow.

12. The method of claim 11, comprising placing a second shim comprising a U-shaped cross-section geometry between the adjacent turbomachinery components, wherein a portion of the second shim overlaps a portion of the first shim to provide a seal between the first and second shims.

13. The method of claim 11, wherein placing the first shim and insert between adjacent turbomachinery components comprises placing the first shim between adjacent components to form a seal at a corner of the adjacent components.

14. The method of claim 11, wherein placing the first shim and insert between adjacent turbomachinery components comprises placing the first shim between non-aligned adjacent components.

15. The method of claim 11, wherein placing the first shim and insert between adjacent components comprises placing the first shim between one selected from the group consisting of: adjacent shroud assemblies, adjacent transition pieces, nozzles and buckets.

16. The method of claim 11, wherein placing the first shim and insert between adjacent components comprises forming a seal configured to prevent fluid flow between adjacent components that form a hot gas path within a turbine.

17. The method of claim 11, wherein coupling the insert to the first shim comprises welding in a staggered pattern.

18. A gas turbine comprising:
an annular array of transition pieces; and
a seal assembly located between each transition piece and the stage one nozzle, the seal assembly comprising a shim coupled to an upper transition piece seal and a lower transition piece seal, wherein a geometry of the shim enables sealing between adjacent non-aligned transition pieces.

19. The gas turbine of claim 18, wherein the geometry of the shim comprises a U-shape.

20. The gas turbine of claim 18, wherein the seal assembly comprises an insert coupled to the shim in a staggered pattern.
